(19) United States
(12) Patent Application Publication
(10) Pub. No.: US 2005/0115611 A1
(43) Pub. Date: Jun. 2, 2005

(54) Raven meter box lid. RML-1118, RML-1324, RML-1416, RML-1527, RML-1730 & RML-2436

(76) Inventor: Donald James Henderson, Meridian, ID (US)

Correspondence Address: DONALD JAMES HENDERSON, 3021 W FIELDSTREAM DR., MERIDIAN, ID, 83642, US

(21) Appl. No.: 10/953,977

(22) Filed: Sep. 29, 2004

Related U.S. Application Data
(60) Provisional application No. 60/513,717, filed on Oct. 24, 2003.

(51) Int. Cl. F16K 27/00

(52) U.S. Cl. 137/364

(57) ABSTRACT

(1). Polyethylene lids will provide an alterative to the heavy iron and cement lids used today. Water utility managers are asking for a lighter lid because they have had a great deal of problems and endured excessive medical expenses and loss of trained workers, caused by injured backs and hands trying to lift and set heavy lids from awkward positions. There is a growing number of employees in maintenance and construction work who are not as strong as their male counterparts or as young. These lightweight durable lids eliminate back and hand injuries while providing all of the listed advantages. (2). Polyethylene lids are easier to drill holes in, too accommodate new touch read and radio read antenna modules. (3). Polyethylene lids will not rust or corrode causing loss of strength. Will maintain a shinny black surface without rusting. (4). Will support foot traffic and lawn maintenance equipment without distortion or cracking.

### CROSS REFERENCE TO RELATED APPLICATIONS

Provisional application No. 60/513,717

### STATEMENT REGARDING FEDERALLY SPONSORED RESEARCH OR DEVELOPMENT

Not applicable.

### BACKGROUND OF THE INVENTION

Rectangular Polyethylene water meter boxes have utilized lids made of other materials such as cast iron, ductile iron, concrete, polyvinyl chloride and composite cement. Polyvinyl lids deteriorated and become brittle when exposed to sunlight (ultraviolet radiation) for relatively short periods of time. The other lid materials are extremely heavy causing installation and maintenance workers to loose time do to back strains and hand injuries. Workmen's compensation payments and the loss of trained workers prompted water companies and city utilities to ask for a lightweight yet durable lid.

Raven's lids are made of Polyethylene and are black so ultraviolet degradation does not occur.

Raven's Polyethylene lids are lightweight, easy to carry, install and maintain yet able to withstand lawn maintenance equipment and casual traffic loads.

### BRIEF SUMMARY OF THE INVENTION

1). Raven rectangular box lids are made of High Density Polyethylene regrind resin so they weigh less than iron or cement lids. Easier to install and maintain without damage to workers backs and hands.

2). Lids are made to recess into the lid area of the water meter box, not sit on top, with a dust plate around the box lid circumference.

3). Lid interior has a cross section of tapered cones (I beams) to provide strength against live loads.

4). Lids interior sections are hollow around the angled beams. Fill this area with foamed polyethylene for increased strength and for a thermal barrier.

5). Lids have rounded corners on all four sides (not square) for easy installation and removal.

6). Lids have a 7.5″×4.5″ cast iron or ductile iron reader lid in the center of the box lid so that the water meter can be manually read without lifting the entire box lid. Cast and ductile lids are used to keep lawn equipment from lifting the lids due to updraft and causing damage to the lawn mower blades or destroying the reader lid. Reader lid rotates on an all-thread pin inserted through the side of the box lid.

7). Lids have 1 or 2 round recessed areas on each lid that are 4½″ across by ⅜″ deep to place future touch read or radio read antennas. The antennas require a 1¾″ hole drilled into this recessed area for future conversion from manual reading to the labor saving touch read and radio read water meters. Polyethylene requires far less equipment and crew time to drill. The recess allows snow removal without damaging the antenna module, also prevents pedestrian traffic from tripping on the otherwise elevated antenna.

8). Lids have metal anchor bolts at each end. These bolts are L shaped and rotate under the lid too secure the lid into place so vandals cannot remove lids to steal, damage or alter meters.

9). Lids have a rough non-slip indented grid surface molded into the top portion of the lid.

10). Lids are made BLACK to retard ultraviolet degradation.

### BRIEF DESCRIPTION OF SEVERAL VIEWS OF THE DRAWING

FIG. 1. Drawing shows view of the bottom and top of the Polyethylene lids. Lids are rectangular in construction, manufactured in various sizes to accommodate existing water meter boxes. Lids are one and three quarters too two inches thick. Interior is hollow with a wall thickness of from three eights inch to half and inch. Lids are rotomolded, this process is not exact and a multitude of resins may be used.

FIG. 2. Extended dust cover is an extension at the top of the lid, a flange, extending beyond the lid. The water meter box is installed with the lid level with the top of the ground, without this extension the lid would fit into the lid area of the box leaving a gap between the box and lid. Dust, air born dirt and sand are now kept from filling the area left between the lid and the top of the water meter box. When this area has been allowed to fill, especially with sand, the lid is almost impossible to remove.

Rain and irrigation water are also kept from flowing through this area into the box.

FIG. 3. The lid is hollow so the round cup shaped areas on the lid bottom are placed at locations in the lid to create I beam supports. They extend from the base of the lid to the top. Without these supports the lid would not have enough strength to support foot traffic, lawn equipment or casual automobile traffic. Cups are tapered, larger at the base than the top (top of box the closed area). This taper allows the mold to be removed without a vacuum occurring that makes the mold almost impossible to separate from the lid.

FIG. 4. Lids are hollow so can be filled in with foam or manufactured from a foam able resin. Once foamed the lid has greater strength and will create an insulated barrier against frost penetration into the water meter box where the water meter, water pipes, check valves and angle valves are located.

FIG. 5. Corners of each lid are not squared off but round, these radiuses are critical to a proper fitting lid. When exposed directly to the suns radiation the Polyethylene lid will expand at a much greater rate than that of the lid area of the box the lid is sitting in or about to be installed into. The round corners create a more forgiving fit without a sloppy too large appearance. This is also why description FIG. 2 (lid extensions around the perimeter of the lid) are important. As the lid contracts in cold weather the gap left between the lid and lid area of the box is covered by these extensions and does not fill with sand.

FIG. 6. Lids have a smaller Ductile Iron manual reader lid that can be of various size. They are made of Ductile Iron because the weight is needed to keep lawn equipment vacuum from lifting the lid into the blade. They are used to visually read the water meter without lifting the entire Poly lid. Polyethylene lids are also manufactured without the manual reader lid where touch and radio read water meters are used.

FIG. 7. Round recessed areas in the top of the lid are sized for touch read or radio read antenna modules. One or two may be positioned at one end or one at each end of the lid. When touch read or radio read antenna modules are used they are currently mounted on the top of the metal or concrete lids. This creates a problem when in foot traffic areas with the danger of tripping over them and when in areas of snow or blowing sand, removal equipment damages or shears them off if not recessed.

FIG. 8. Locking anchor bolts are three eights inch around and are L shaped. Bolts are threaded at one end and plain at the other. One bolt has a nine sixteenth inch nut welded on the top of the treaded portion. The Polyethylene lid has a recessed area on one end for the nut to sit in so that the nut only has enough clearance for a socket to be inserted to rotate the bolt. When the bolt is rotated the lower portion of the L slides under the lid support on the box creating a locked in lid. Cities want to protect their investment against vandalism and residents who think they can alter the meter reading equipment.

FIG. 9. A rough non-slip indented grid surface molded into the entire top portion. This surface if set into the lid mold.

FIG. 10. Black lids eliminate damage from ultra violet degradation caused by continuous exposure to direct sunlight. Carbon-Black is added to the regrind resin for this purpose and to make the multi color regrind resin a solid black.

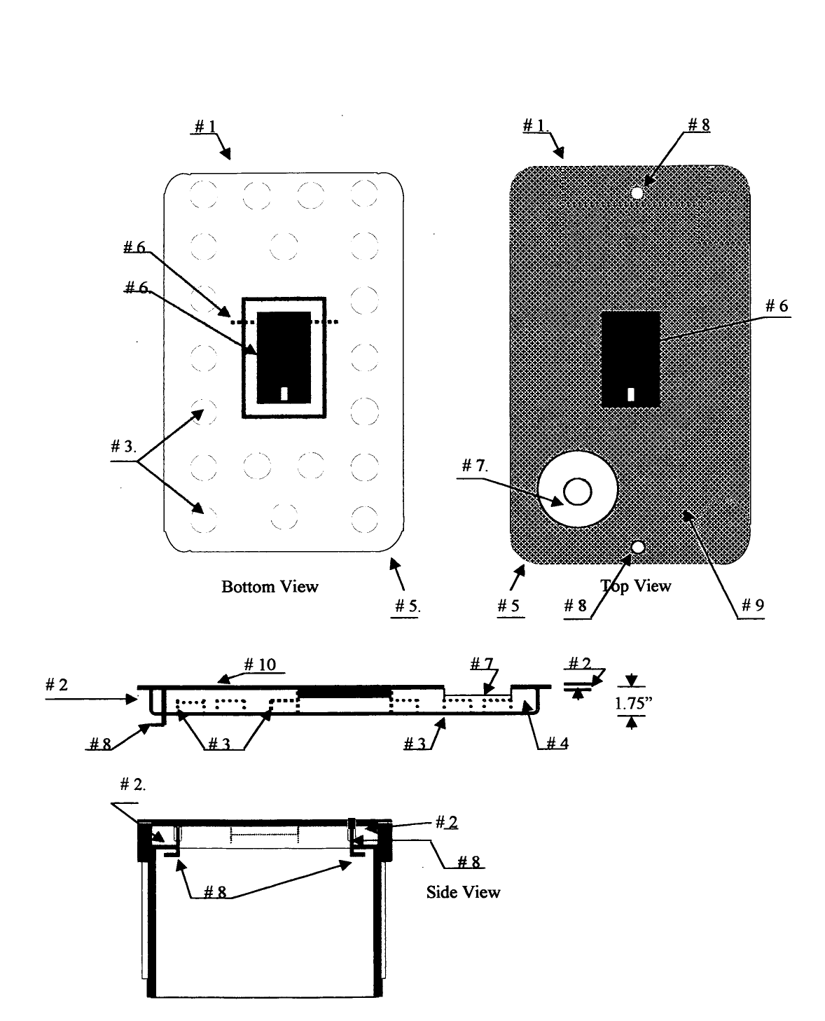

### DETAILED DESCRIPTION OF THE INVENTION

Each home, apartment, office, manufacturing facility any building with running water that a water utility or city water department provides with drinking water is usually metered. Metered water provides the utility or city with a way of charging for the water service. A water mainline is buried in the street in front of the building, then a corporation stop is placed in the pipe and attached to a copper or HDPE pipe. This is called a water service. The service pipe, still under ground, is then routed to a water meter and backflow device then attached to the pipe going into the building. The water meter and back flow device are below ground so in need of a void area free of dirt where the meter can be read and the building billed for water used. Meter boxes are used to provide this underground area, a hole is excavated to the depth of the service and the meter box installed and backfilled. The meter setter is now installed with the meter and backflow valve. The meter box is open at the bottom and the top. Now the top of the meter box must be covered with a removable lid so foot and wheel traffic will not fall in or damage meter. (1) Raven lids are made of High Density Polyethylene so they are lightweight yet strong, (2) the lid is recessed into the top of the box so will stay in place, (3) tapered cones in lid will carry external loads, (4) can be insulated to protect water meter, valves and pipe from freezing, (5) rounded corners make lid easier to remove, (6) small iron flip lid for easy manual reading, (7) recess for future conversions that will set antenna into lid to prevent pedestrians from tripping and damage from snow removal, (8) rotational anti theft locking anchor bolts, (9) grid surface to prevent slippage and Black to prevent damage from direct sun exposure.

1. Water meter box lid is rectangular, made of High Density Polyethylene Regrind Resin.

2. Water meter box lid installs into the box lid area instead of on top of the box with dust covers.

3. Water meter box lid reinforced with round tapered vertical beams.

4. Water meter box lid interior can be insulated and strengthened with aerated resin.

5. Water meter box lid corners are rounded.

6. Water meter box lid has a 7.5″×4.5″ cast or ductile iron reader lid on all-tread pin.

7. Water meter box lid has one or two 4½×⅜″ recessed area in corner (s) of lid.

8. Water meter box lid has rotational locking anchor bolts at each end.

9. Water meter box lid has non-slip indented grid on top.

10. Water meter box lid is black.
